(19) United States
(12) Patent Application Publication
(10) Pub. No.: US 2005/0186309 A1
(43) Pub. Date: Aug. 25, 2005

(54) Flexible-hose shaped edible foodstuff wrapper produced according to the amino oxide method

(76) Inventors: Herbert Gord, Ingelheim (DE); Klaus-Dieter Hammer, Mainz (DE); Rainer Neeff, Wiesbaden (DE); Klaus Berghof, Schwarza (DE); Markus Eilers, Wietmarschen-Lohne (DE); Eberhard Taeger, Weissbach (DE)

Correspondence Address: Klaus Schweitzer;ProPat, 425 C South Sharon Amity Road, North Carolina, NC, 28211, US

(21) Appl. No.: 10/512,519

(22) PCT Filed: Jul. 14, 2003
(86) PCT No.: PCT/EP03/07585

(30) Foreign Application Priority Data
Jul. 15, 2002 (DE) 102-31-810.7

(51) Int. Cl. A23L 1/31

(52) U.S. Cl. 426/105

(57) ABSTRACT

The invention relates to tubular, edible food casings which include cellulose, at least one protein and at least one filler in which the ratio of the wet tear strength in the transverse direction to the wet tear strength in the longitudinal direction is from 1.3:1 to 1:3.5. The casing is gathered to form a shirred stick which is particularly suitable for processing on high-speed stuffing machines. The sticks can be deshirred and stuffed with sausage meat emulsion without difficulty on the stuffing horn. The sticks are particularly suitable in the production of cooked-meat sausages and scalded-emulsion sausages and frying sausages, especially small sausages in which the casing is co-consumed.

The invention relates to a tubular, edible food casing which comprises cellulose, at least one protein and at least one filler.

Edible food casings, that is to say suitable for co-consumption, have long been known. The edible sausage casings used in practice are natural gut skins of cattle, in particular of pig or of sheep, or collagen skins. The collagen skins are produced from the fibrous tissue of animal hide which, in tanneries, is separated off from the inside of the dehaired fresh, salted or slightly limed skin by special machines (see G. Effenberger, Wursthüllen—Kunstdarm [Sausage casings—artificial skin], Holzmann Buchverlag, Bad Wörishofen, 2nd edition [1991], pp. 26/27). They are therefore termed hide fiber skins. Natural gut skins, and also collagen skins, have become an increasing problem as a result of animal diseases, such as BSE.

In DE 101 29 539, which was unpublished at the priority date of the present application, discloses edible food casings which are not produced from animal tissue. These casings essentially consist of cellulose, (vegetable) protein and filler. They are produced by the N-methylmorpholine N-oxide (NMMO) method. In this method the cellulose and the protein are dissolved in NMMO hydrate and mixed with the filler. The mixture is then extruded through a ring die. The resultant tubing first passes through an approximately 2 to 30 cm long air section before it enters the precipitation bath. In the precipitation bath, regeneration is performed by precipitation liquid, which acts on the tubing from the inside and outside. The precipitation liquid is generally an approximately 15% strength by weight aqueous NMMO solution, cooled to about 5° C.

The described collagen skins, and also the casings based on cellulose, protein and filler, are frequently offered in a form in which in each case about 15 to 50 m of the casing is concertinaed to form about 20 to 60 cm long sticks. The shirring of the artificial sausage skin has long been known and it is copiously described in the general specialist literature and also in the patent literature (see G. Effenberger, loc. cit., pp. 58-60). It is carried out on shirring machines. Before shirring, the casing is laid flat and rolled up. It is then taken off from the roll, inflated and pulled onto the shirring mandrel of the shirring machine. The outer diameter of the shirring mandrel determines the inner diameter of the stick to be produced. Shirring is high stress for the casing. Immediately before or during shirring it is therefore customarily sprayed or wetted with water and/or oil from the inside, from the outside or from both sides, in order to make it more supple. This prevents cracks from forming on the pleat folds. The shirring tools themselves can have quite different structures. For example, shirring wheels are known which can be smooth or toothed on the outside, and also circulating belts. When the desired number of meters has been shirred, the casing is cut off. The stick thus produced is to be as dimensionally stable and self-supporting as possible. For storage and transport, it is nevertheless frequently provided with an outer packaging (generally a net or a film). Finally, casings are also known which are shirred onto a dimensionally stable sleeve. The stick is de-shirred again on stuffing with sausage meat emulsion. Frequently, several sticks are placed into a storage vessel from which individual sticks are then automatically taken out and pushed onto the stuffing horn of the high-speed stuffing machine. It is of critical importance that the stick does not break. Otherwise a fault in the production sequence occurs, which must be laboriously cleared by hand.

After the stuffing, the required portioning of the sausages and sealing or tying off the sausage ends is usually likewise performed automatically. In this manner, inter alia, small sausages are also produced. The portioning of the small sausage meat emulsion is performed by the pump of the stuffing machine. During each interruption of the transport process, by winding off, the corresponding small sausage length is produced. The entire process proceeds fully automatically at high speed. The chain of the small sausages thus produced is, likewise mechanically, suspended on a suitable rack on which the small sausages are then brought directly into the further treatment stages. The casing remains on the sausage and is co-consumed.

The storage life of the collagen-based sticks is extremely short under standard conditions. To increase the storage stability and ensure processability, extensive measures are necessary. Before it is introduced into the sale packaging, extensive conditioning of the sticks to set the moisture content is necessary. Storage and transport are only possible under cooling. Because of the ease of spoilage, after opening of the package, rapid processing is necessary. A further disadvantage is the unsatisfactory stability of the end seal of the stick.

The object was therefore to provide an edible artificial sausage casing which no longer exhibits the disadvantages described. In particular, the casing, in shirred form is to have a markedly improved storage stability and insensitivity toward direct air contact. Furthermore, the stability of the end closure is to be markedly greater, that is to say the end closure is to have a firmer seat on the casing. The casing is also to be able to be stuffed without problems. For this it must have a sufficient mechanical stability so that this does not burst on stuffing. In addition, it was the specific object to further develop the edible cellulose-based food casing disclosed in DE 101 29 539 mentioned at the outset and to find advantageous end-processed forms therefor.

The properties of an edible casing of the type mentioned at the outset may be markedly improved if, in the air section between ring die and surface of the precipitation bath, controlled transverse stretching by means of a gas pressure acting in the interior of the tubing takes place.

The present invention therefore relates to a tubular, edible food casing which comprises cellulose, at least one protein and at least one filler and wherein the ratio of the wet tear strength in the transverse direction to the wet tear strength in the longitudinal direction is from 1.3:1 to 1:3.5. Preferably, the ratio is 1:1.2 to 1:2.5. In absolute figures, the wet tear strength (determined as specified in DIN 53455) in the transverse direction is preferably about 3 to 6 N/mm², and the wet tear strength in the longitudinal direction is preferably about 5 to 12 N/mm². Without transverse stretching the wet tear strength in the transverse direction it is only about 1 to 2 N/mm². A casing having such a low tear strength in the transverse direction would scarcely be able to be handled and would only be able to be stuffed with great difficulty.

The inventive casing is produced by the NMMO process. This process utilizes the fact that cellulose and certain proteins are soluble in oxides of tertiary amines without chemical change (derivatization) and without significant degradation of the molecule chains. N-methylmorpholine N-oxide (NMMO) has proved to be a surface of the precipitation bath, controlled transverse stretching by means of a gas pressure acting in the interior of the tubing takes place.

The present invention therefore relates to a tubular, edible food casing which comprises cellulose, at least one protein and at least one filler and wherein the ratio of the wet tear strength in the transverse direction to the wet tear strength in the longitudinal direction is from 1.3:1 to 1:3.5. The ratio is 1:1.2 to 1:2.5. In absolute figures, the wet tear strength (determined as specified in DIN 53455) in the transverse direction is about 3 to 6 N/mm², and the wet tear strength in the longitudinal direction is preferably about 5 to 12 N/mm². Without transverse stretching the wet tear strength in the transverse direction it is only about 1 to 2 N/mm². A casing having such a low tear strength in the transverse direction would scarcely be able to be handled and would only be able to be stuffed with great difficulty.

The inventive casing is produced by the NMMO process. This process utilizes the fact that cellulose and certain proteins are soluble in oxides of tertiary amines without chemical change (derivatization) and without significant degradation of the molecule chains. N-methylmorpholine N-oxide (NMMO) has proved to be a particularly suitable amine oxide. During preparation of the solution, at least one finely ground filler is added which remains in suspension.

If appropriate the cellulose can be exchanged for another backbone carbohydrate, such as carrageenan. For further modification of the properties, in particular chewability, additional organic or inorganic fillers, if appropriate also short fibers, are added to the spinning solution.

The mean degree of polymerization DP of the cellulose is preferably 300 to 1900, preferably 400 to 900. Other than in to the film surface, so that their length can also be greater than the thickness of the film.

Particularly suitable organic fillers are bran, in particular wheat bran, chitosan, guar seed meal, carob bean meal or microcrystalline cellulose. Wheat bran, in the course of processing, adopts a brown color due to the known Maillard reaction and as a result also gives the casing this color. With other fillers, such as waxy corn starch (having a mean particle size of less than 50 μm), crystalline polylactide or crosslinked polyvinylpyrrolidone (particle size about 20 to 80 μm, preferably 30 to 60 μm), a colorless casing may also be produced. Instead of the organic fillers or in addition, finely divided inorganic fillers can also be used. Examples of these are pulverulent CaCO₃, BaSO₄, CaSO₄, SiO₂ or TiO₂. The content of filler(s) is generally 10 to 70% by weight, preferably 30 to 60% by weight, in each case based on the dry weight of the casing.

The spinning solution preferably comprises about 3 to 15% by weight of cellulose, about 1 to 10% by weight of protein and about 3 to 15% by weight of filler, in each case based on the total weight of the spinning solution. 60 to 90% by weight of the solvent present in the spinning solution consists of NMMO monohydrate. These parameters, together with the temperature essentially determine the viscosity and the flow behavior of the spinning solution.

If required, the solubility of the fillers in NMMO monohydrate can be reduced by precrosslinking. As do the proteins, the fillers interrupt the structure of the cellulose. They decrease the extensibility without impairing strength.

The spinning solution is extruded through the annular die preferably at a temperature of 85 to 105° C. The annular slit is generally 0.1 to 2.5 mm, preferably 0.2 to 1.0 mm wide. The width must be matched to the “warp” (quotient of exit velocity and take-off rate).

The air section, that is to say the section between annular slit and surface of the spinning bath, in which the film blowing takes place is preferably 1 to 50 cm, particularly preferably 2.5 to 20 cm. It also depends on the diameter (caliber) of the tubular film after the film blowing.

The film is blown by compressed air or other gases which pass through orifices in the die body into the interior of the tube. Stretching in the transverse direction considerably increases the transverse strength of the tube.

Through appropriate apparatuses in the die body, spinning bath solution also passes into the interior of the cellulose tube. The surface of the internal bath situated in the interior of the tube in this case is generally at about the same height as that of the outer bath, but can be somewhat higher. By means of the inner bath, the tube solidifies more rapidly; at the same time this prevents the inner sides of the tube from sticking together.

For further solidification, the laid-flat tube then passes through a plurality of further NMMO-containing precipitation vats. The NMMO content in the first precipitation vat is about 10 to 20% by weight, preferably about 15% by weight. It decreases in the following vats. The temperature in the precipitation vats increases stepwise and in the last vat reaches 70 to 80° C.

The precipitation section is followed by vats filled with water of 40 to 60° C., in which vats last traces of NMMO are removed from the tube. Then, a plasticizer vat follows. This contains an aqueous solution of a plasticizer for cellulose. Suitable plasticizers are polyols and polyglycols, particularly glycerol. In accordance with the intended use, the casings can, furthermore, be provided on the inside and/or outside with an impregnation or coating, for example a liquid smoke impregnation or a finish to further increase the stick stability. The material is then dried. The diameter corresponds thereafter to roughly the original die diameter, and preferably it is above this.

The moisture content on leaving the dryer ranges from 8 to 20%. By varying the longitudinal/transverse warping during drying, particular properties can be imparted to the material, depending on the later application. After leaving the dryer, the tube can again be moistened to a water content of 14 to 24% by weight, preferably 16 to 18% by weight, in each case based on the total weight of the tube. Then, using a squeeze-roll pair, it can be laid flat and wound up. The nominal caliber for the inventive casing is 14 to 50 mm, preferably 16 to 30 mm.

The following amounts have proven particularly suitable compositions of the finished tube:
20 to 60% by weight of cellulose
10 to 30% by weight of protein;
10 to 70% by weight of filler (organic and/or inorganic)

The edible food casings produced by the NMMO method can be shirred by methods known per se. Suitable shirring methods are, for example, described in DE-B 12 68 011, DE-C 16 32 137, 21 47 498 and also 22 36 600. In the shirring, in each case about 10 to 50 m, preferably about 16 to 30 m, of the casing is gathered to form a shirred stick.

The casing compressed to form a stick must already be provided with a closure at one end so that the stuffing does not pass out onto the stuffing bench and contaminate the following sausage chain. The closure must be formed in such a way that it prevents the outlet of sausage emulsion, but not the outlet of air, since otherwise the pressure equilibration in the interior would be hindered. When use is made of additional, separate closure materials, such as clips or clamps made of plastic or metal, there is always the risk that these will pass together with the sausage emulsion into the sausage interior. It is therefore advantageous if the closure is formed from the casing material itself by twisting or knotting (DE-C 12 97 508, 15 32 029, 23 17 867; EP-A 129 100).

Frequently the end closure is produced by drawing out a short piece of the stick using special tongs and, after a short turn, pushing it back into the stick interior. Another possibility is, using a specially shaped striking pin, to deform and simultaneously push into the inner borehole the last millimeters of the stick.

By means of the described NMMO process, edible casings may be made in an environmentally friendly manner and in markedly fewer process steps than was hitherto customary. The resultant casings, furthermore, exhibit marked advantages compared with the known collagen-based casings. This relates in particular to the simpler conditioning before shirring, the storage stability of the sticks themselves under standard climatic conditions and the longer shelf life after the package is opened. In addition, the processing procedure is significantly safer owing to the more stable end closure.

Additional conditioning of the sticks before packaging is not necessary. In addition, the material, in the packaged state, can be stored without special cooling or climate measures and without change of the mechanical properties. In addition, after the package is opened and the resultant ingress of air, no microbial attack leading to damage of the material takes place.

The inventive shirred stick is particularly suitable for processing on high-speed stuffing machines. The sticks can be deshirred and stuffed with sausage meat emulsion without problem on the stuffing horn. The inventive sticks are particularly suitable in the production of cooked-meat sausages and scalded-emulsion sausages and frying sausages, especially small sausages in which the casing is co-consumed.

The examples hereinafter serve for more detailed explanation of the invention. Percentages therein are percentages by weight unless stated otherwise or it is obvious from the context.

### EXAMPLE 1

An edible tube of caliber 22 mm was produced by the amine oxide method and plasticized with glycerol, dried and wound up. The composition of the solid portion was 40% cellulose, 10% zein and 50% milled wheat bran.

Furthermore, the tube had a water content of 18% and a glycerol content of 25%, in each case based on the total weight of the casing.

The intermediate storage was performed in a climatically controlled chamber. In the subsequent shirring, the tube was taken off from the roll and shaped in sections each of 16.7 m in length by one of the known shirring methods, with application of triglyceride, to give an approximately 34 cm-long stick.

In a subsequent step, the stick was then provided with an end closure. For this the sticks were individually pushed into an appropriately shaped apparatus and the last pleats forced with mechanical deformation into the stick borehole. The sticks, packaged in film, were then placed in a carton. The film was shaped in such a manner that the sticks could be removed by the consumer without risk of breakage and transferred to the magazine of the automatic stuffing machine.

One portion of the material was immediately stuffed on an automatic stuffing machine (®FrankAMatic) with sausage meat emulsion, scalded and smoked. A second portion of the sticks were processed in the same manner only after 3-month storage under room conditions. In this case the sticks had the same properties with respect to strength and moisture content. In both cases good processing behavior was observed. The sausages could be bitten and chewed without problem.

### EXAMPLE 2

An edible tube of caliber 26 mm was produced by the amine oxide method and plasticized with glycerol, dried and wound up. The composition of the solid portion was 30% cellulose, 20% zein, 25% milled wheat bran and 25% CaCO₃.

Furthermore, the tube had a water content of 18% and a glycerol content of 25%, in each case based on the total weight of the casing.

The intermediate storage was performed in a climatically controlled chamber. In the subsequent shirring, the tube was taken off from the roll and shaped in sections, each of 16.7 m in length, by one of the known shirring methods, with application of triglyceride, to form an approximately 36 cm-long stick.

In a subsequent step, the stick was then provided with an end closure. For this the sticks were individually pushed into an appropriately shaped apparatus and the last pleats were forced with mechanical deformation into the stick bore hole. The sticks, packaged in film, were then placed in a carton. The film was shaped in such a manner that the sticks could be taken out by the consumer without risk of damage and transferred to the magazine of the automatic stuffing machine.

Further processing was performed as described in example 1. The sticks had identical properties with respect to strength and moisture content. In both cases, a good processing behavior was observed. The sausages could be bitten and chewed without problem.

1. A tubular, edible food casing which comprises cellulose, at least one protein and at least one filler, wherein the wet tear strength in the transverse direction is from 3 to 6 N/mm² and in the longitudinal direction is from 5 to 12 N/mm² and wherein the ratio of the wet tear strength in the transverse direction to the wet tear strength in the longitudinal direction is from 1.3:1 to 1:3.5.

2. The casing as claimed in claim 1, wherein the ratio of the wet tear strength in the transverse direction to the wet tear strength in the longitudinal direction is from 1:1.2 to 1:2.5.

3. (canceled)

4. The casing as claimed in claim 1, wherein the cellulose has a mean degree of polymerization DP from 300 to 190.

5. The casing as claimed in claim 1, wherein the cellulose content is from 20 to 70% by weight based on the dry weight of the casing.

6. The casing as claimed in claim 1, wherein the protein is a natural globular protein.

7. The casing as claimed in claim 6, wherein the content of the at least one protein is from 5 to 50% by weight based on the dry weight of the food casing.

8. The casing as claimed in claim 1, wherein the filler is an organic filler.

9. The casing as claimed in claim 1, wherein the filler is an inorganic filler.

10. The casing as claimed in claim 1, wherein the content of filler(s) is from 10 to 70% by weight based on the dry weight of the casing.

11. The casing as claimed in claim 1, wherein it has a nominal caliber of from 14 to 50 mm.

12. The casing as claimed in claim 1, wherein it comprises from 8 to 24% by weight.

13. The casing as claimed in claim 1, wherein it comprises a plasticizer.

14. The casing as claimed in claim 1, wherein from about 10 to 50 m thereof is shirred to form a stick.

15. The casing as claimed in claim 14, wherein the stick is provided with an end closure.

16. The casing as claimed in claim 14, wherein the stick is surrounded by an air-tight and water vapor-tight packaging.

17. (canceled)

18. The casing as claimed in claim 6, wherein the natural globular protein is casein, soybean protein, gluten, zein, ardein or pea protein.

19. The casing as claimed in claim 8, wherein the organic filler is bran, chitosan, guar seed meal, carob bean meal, microcrystalline cellulose, waxy maize starch, crystalline polylactide, or crosslinked polyvinylpyrrolidone.

20. The casing as claimed in claim 9, wherein the inorganic filler is particulate CaCO₃, BaSO₄, CaSO₄, SiO₂ or TiO₂.

21. The casing as claimed in claim 13, wherein the plasticizer is glycerol.
